(19) United States
(12) Patent Application Publication
(10) Pub. No.: US 2016/0262241 A1
(43) Pub. Date: Sep. 8, 2016

(54) Lighting Control Network Commissioning

(71) Applicant: Orama Inc., San Mateo, CA (US)

(72) Inventor: Hong Jyeh Huang, San Mateo, CA (US)

(21) Appl. No.: 15/012,799

(22) Filed: Feb. 1, 2016

Related U.S. Application Data
(60) Provisional application No. 62/111,051, filed on Feb. 2, 2015.

(51) Int. Cl. H05B 37/02; H04L 29/08

(52) U.S. Cl. CPC H05B 37/0209; H04L 67/12

(57) ABSTRACT

A method for automated location of a targeted network lighting device includes setting a search pool of multiple network lighting device. The method includes iteratively selecting the network lighting devices and automatically turning on a portion of the network devices until the targeted network device is the only network lighting device turned on. Other methods are also described.

### CROSS-REFERENCE TO RELATED APPLICATIONS

This application claims the benefit of U.S. Provisional Application No. 62/111,051, filed Feb. 2, 2015, which is hereby incorporated by reference.

### FIELD

The present invention relates generally to the commissioning of lighting control systems.

### BACKGROUND

FIG. 1A illustrates the simplest form of a lighting control system 100, where a switch 104 draws power from the power source 102 through wire 103 and provides the interface for the user to connect the power from source 102 onto the power circuit 108 to power all the lighting devices 106 attached. System 100 provides control of all the devices 106 attached as one single entity via switch 104 which is referred to as a group/zone. While on/off control is typical of system 100, the use of Triode for Alternating Current (TRIAC) switch in lighting control provides added dimming capability.

However, system 100 is a hard wired system and therefore once the wiring is complete, the group can be altered only by labor intensive re-wiring. The quest for more control abilities and flexibility in grouping of a system led to control system 120 as illustrated in FIG. 1B. The control channel 128 is added in system 120 for control signaling. Furthermore, the attached switch device 124 and the attached lighting devices 126 are now equipped with an appropriate control interface. In addition, a controller or commissioning device 122, such as a tablet, laptop, a hand-held computer, or a combination of a server with the attached application software, is also part of the network control system especially during the process called commissioning. Note that although control switch 124 is able to issue control signals through the control network 128, it is also equipped with the same power control capability as switch device 104.

Whereas older control systems 120 have been wired systems, wireless control systems have become competitive. Regardless of wired or wireless systems, control system 120 must go through a process called commissioning whereby the control of the devices are configured according to a system specification. The creation of control groups/zones is a fundamental part of lighting control. FIG. 1C illustrates an exemplary specification where the lighting system 130 is to be configured into three control zones: 162, 164, and 168.

While all network control systems are capable of creating the desired zones, existing commissioning tools/methods are complex, outdated, and require highly trained technician making the commissioning of the control network very costly.

Network switch devices 124 and network lighting devices 126 by default are equipped with the appropriate hardware and software protocol to connect to the control network 128. After the network devices are connected to the network, however, they are just a bunch of devices physically distributed in the premise and addressable by their respective network identifications such as the IP addresses in the case of an IP network. There is no information linking the network identification of an individual network device to the where about of the device. Without knowing which physical device the network identification represents, the commissioning tool/software would have no reference point to create the desired zones 162, 164, and 168 in system 130.

The first and foremost function of commissioning is to bind/map the network devices' physical presence to their respective logical representations in the control system such as in the control software/database of the commissioning server device 122.

A commonly practiced binding process is the “label and map method” where each network device is tacked with a label matching its hardware network identification (like a MAC address) at manufacturing. The electrician is then given a floor-plan/map of the installation and instructed to take the label off the device and stick it on the floor-plan/map matching the physical location where the device is installed. After all the devices are installed, assuming the electrician did not make any mistake on sticking the labels, the floor-plan/map filled with devices labels is handed to the trained commissioning technician with which he will laboriously create the logical representation of all the devices matching their physical location in the application software. This process inherently costs money because of the additional device identification labels, the labor cost of the electrician and the technician, and occasionally a huge cost stemming from errors from the electrician and technician.

Yet another deficient method for binding is the use of a “locating wand” where a pointing device fitted with either a close range RF or an directional IR functions to remotely trigger the pointed device (such as a light fixture in the ceiling that is not readily accessible by the person) to send its device identification over the network which is then captured by the commissioning application for binding. This is also a time consuming task as one has to get close to every device of the network to map them one at a time. Furthermore, these pointing devices are only used during binding and therefore are an extra cost and extra equipment to keep inventory of.

While typically the grouping process comes after binding, there are ways to perform grouping before binding. A traditional lighting wall switch powering a number of lamps forms a control group by nature of the AC power circuit. It is very natural and advantageous to automatically create the same logical grouping for a network switch along with the group of network light fixtures connected to the power circuit of the network switch for example. Patent U.S. Pat. No. 8,265,674, wireless system commissioning, provides an improved method for automatically generating groups based on devices attached to the power circuits of the AC relay of the switch by monitoring the devices' wireless presence. While it is a step in the right direction, it is deficient in the following ways: (1) the auto-commissioning has to be serialized for each wireless switch because of the shared wireless media; therefore it can take a long time if there is a large installation with many switches; (2) due to the potential interference from wireless devices outside the control system, the algorithm uses multiple loops to confirm the accuracy of the grouping established; (3) variables in the amount of time that wireless device establish a connection to the network creates an arbitrary time expiration that may or may not achieve a complete commission of the system; and (4) it works only on wireless networks.

Existing commissioning application software (tools) facilitating the whole commissioning process are outdated, complex, and require highly trained technicians. Starting with their user interface, excessive amount of time is spent traversing the hierarchy of menus to accomplish anything Most of these application software tools also rely heavily on text based naming to identify things. As a result, one spends hours on the creation and typing of unique names for devices and zones. More time is again wasted when typing names to retrieve the entities (device, group, floor plan, etc.). The whole process becomes more laborious as the number of network devices in the system grows in the system (e.g., over fifty, which is very common in a commercial, hospitality, hospital, or educational system). Technicians can easily spend days, if not weeks, to commission even a mid-size installation with inefficient commissioning tools and methods. These deficient commission software/tools contribute in large part to the overall high cost associated with commissioning which is a huge hurdle for building owners to deploy network controlled systems such as in building automation and lighting network control.

Therefore, there currently exists a need in the industry for an efficient commissioning tool/method that not only optimizes the user time spent on commissioning but it is also very easy to learn and use by someone with basic computer skills.

### BRIEF DESCRIPTION OF THE DRAWINGS

The invention may best be understood by referring to the following description and accompanying drawings that are used to illustrate embodiments of the invention. In the drawings:

FIG. 1A is a block diagram illustrating an existing control system;

FIG. 1B is a block diagram illustrating an existing network control system;

FIG. 1C is a block diagram illustrating network devices grouped into three zones;

FIG. 2 is a flow diagram that illustrates exemplary operations for performing an automatic binary locate of network devices with simple user feedback according to one embodiment;

FIG. 3A illustrates a first view of the progression of the operations of FIG. 2 within a graphics representation of the configured system according to one embodiment;

FIG. 3B illustrates a second view of the progression of the operations of FIG. 2 within a graphics representation of the configured system according to one embodiment;

FIG. 3C illustrates a third view of the progression of the operations of FIG. 2 within a graphics representation of the configured system according to one embodiment;

FIG. 3D illustrates a fourth view of the progression of the operations of FIG. 2 within a graphics representation of the configured system according to one embodiment;

FIG. 3E illustrates a fifth view of the progression of the operations of FIG. 2 within a graphics representation of the configured system according to one embodiment;

FIG. 4 is a flow diagram that illustrates exemplary operations for performing an auto-grouping program on the network system according to one embodiment;

FIG. 5A illustrates a first view of the Auto-grouping process running on the network-switch according to one embodiment;

FIG. 5B illustrates a second view of the Auto-grouping process running on the network-switch according to one embodiment;

FIG. 5C illustrates a second view of the Auto-grouping process running on the network-switch according to one embodiment;

FIG. 6 illustrates corresponding Auto-grouping processes running on each Network-Device according to one embodiment;

FIG. 7 illustrates the power on and off timing relations between the Network-Switch and the Network-Devices according to one embodiment;

FIG. 8 illustrates how the power on and off timing can be used to create signaling symbols according to one embodiment;

FIG. 9 illustrates the definition of a finite set of equally spaced symbols according to one embodiment; and

FIG. 10 illustrates a process running on the network-device to capture the symbol being transmitted from the network switch

### DESCRIPTION OF EMBODIMENTS

### Overview

The invention describes methods and software that address the aforementioned and other drawbacks of existing commissioning tools/systems.

Another objective is to efficiently reduce the amount of time that the user is required to spend on commissioning by allowing tasks to be performed concurrently in machines as well as for human commissioners.

Another objective is to allow the user to quickly identify and bind a node without the need of an additional apparatus. Binding apparatuses are typically only useful during the commissioning process and are therefore an unnecessary cost. As described later herein, the automatic binary locate process allows the user to quickly identify and bind a node without the need of a specialized binding apparatus.

Another objective is to provide a method so that switch based groupings can be generated concurrently and without any additional tools via simple signaling over the power lines without modulation. This is referred herein as Switch/Relay power circuit/wires based Automatic Grouping.

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

A number of methods which serve as building blocks of an advance commissioning platform will first be described. It will be apparent later that the integration of these methods at the system level with an advance user interface may be used to reduce overall commission time.

Automated Relay Controlled Circuit Based Grouping/Zoning

Automated relay controlled circuit based grouping provides a very powerful method and apparatus for mass automated grouping/zoning of network controlled devices such as control system 130. The process 4000 requires a network-switch device 180 that includes the embedded firmware or state-machine 182 and a built-in relay switch that can control the powering of a power circuit 108. The embedded firmware or state machine 182 of the network-switch device 180 is fairly equipped to generate with reasonable accuracy a timed sequence of power on and power off events on the power circuit 108. The embedded firmware or state machine 182 is also able to execute the auto-grouping process 500.

Process 4000 also requires network-lighting devices 170 that include embedded firmware or state-machine 172 that can capture with reasonable accuracy short timed sequence of power on and power off events on the power circuit 108. The embedded firmware or state machine 172 is able to execute process 600 as part of the Automated Relay Controlled Circuit based grouping process 4000.

The network switch devices 180 and network-lighting devices 170 have persistent memory to store network and configuration information. They are connected in a wired or wireless control network 128. A network commissioning device 190 can be a laptop, tablet, or other computing device that runs application commission software 192 that provides the installer the user interface to trigger process 4000 and automatically manage the process 4000.

The commissioning work starts after the electrician is done with the electrical installation. The network-switch devices 180 connect to the communication network of the system when powered. In the case of the network-switch devices 180, power is provided when the circuit breaker turns on the power to it, but in the case for network devices attached to the power circuits of the individual network-switch device, they may or may not be powered at that same time.

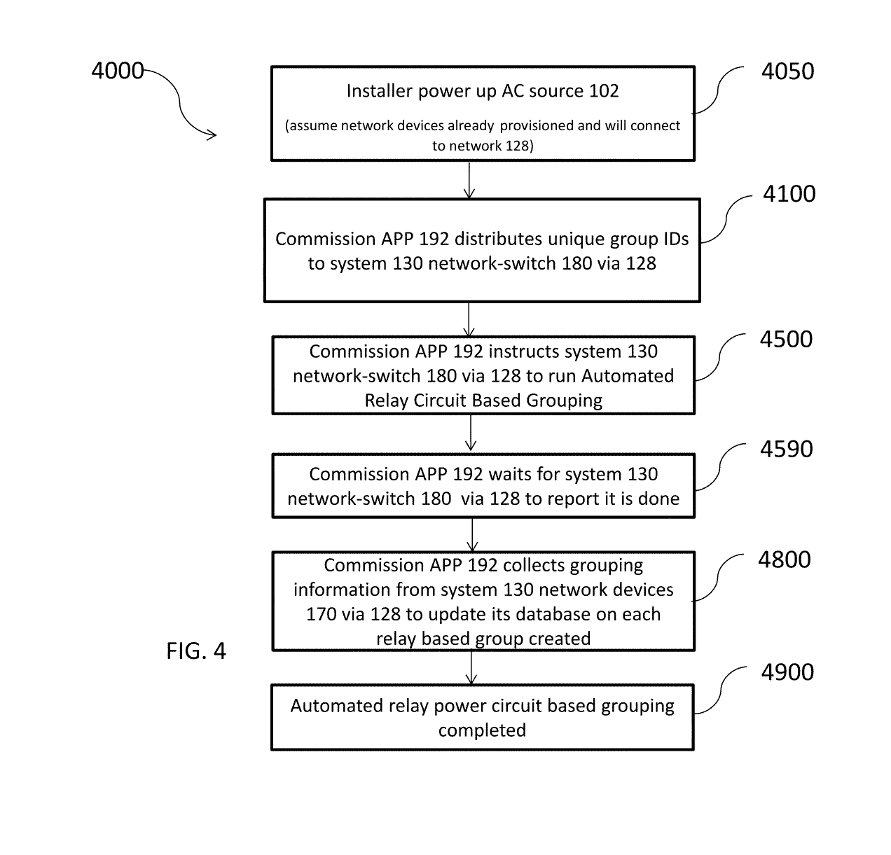

FIG. 4 illustrates process 4000 capable of automatically and concurrently creating relay circuit based groupings 162 and 164 by employing a sequence of timed power on and power off of the relay power circuit 128. Note that the power circuit may be AC or DC power. As part of process 4000, the technician powers up the power source 102 (4050). At this point (4050), all the network-devices (including the network switch devices 180 and the network lighting devices 170) receive power and join the control network 128. Also at this point (4050), network lighting devices 170 of group 168 are not powered directly by a network switch device 180 and they are not part of the automated relay control circuit based grouping process 4000. Based on a database of network switch devices accessible by the application commission software 192 of the commissioning device 190 (e.g., the database may be stored locally on the commissioning device 190 or may be stored remotely and accessed by the application commission software 192), process 4000 creates and distribute a unique group ID (4100) to all the network-switch devices 180 that have joined the control system 130 over the network 128. A unique group ID can be either from a pool of group IDs that the commission software 192 maintains and manages in the database or it can be generated from the unique device ID of the network switch device such as the MAC address of the device. Alternatively, the unique group identification can be negotiated among the network-switch devices 180. After each of the network-switch devices 180 have been issued a unique group ID, a command is issued to all the network-switch devices 180 over the control network 128 to start the automated relay/switch circuit based grouping process (4500). Then, process 4000 waits for all the network-switch devices to report that the automated relay circuit based grouping running on the individual network-switch is complete (4590).

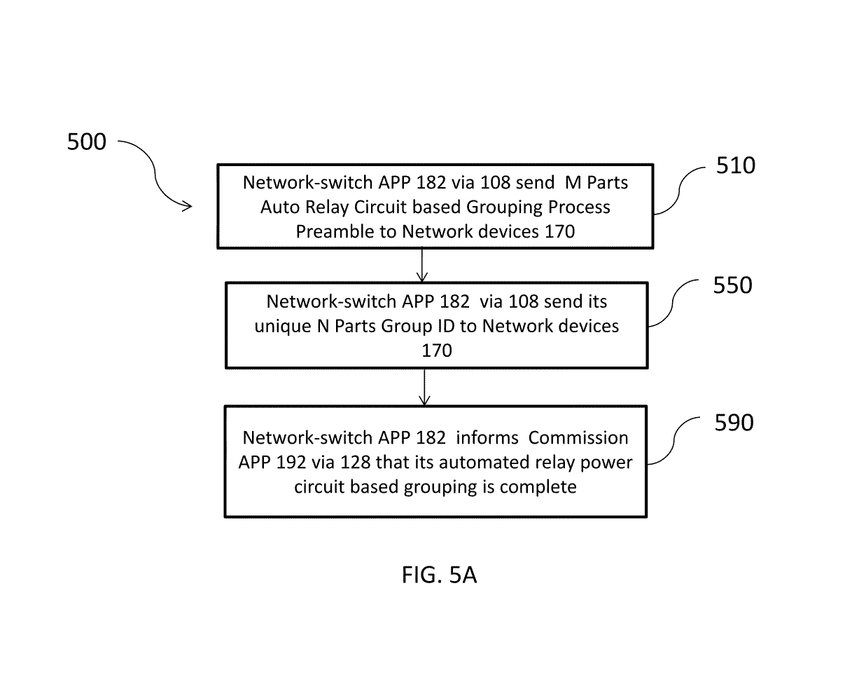

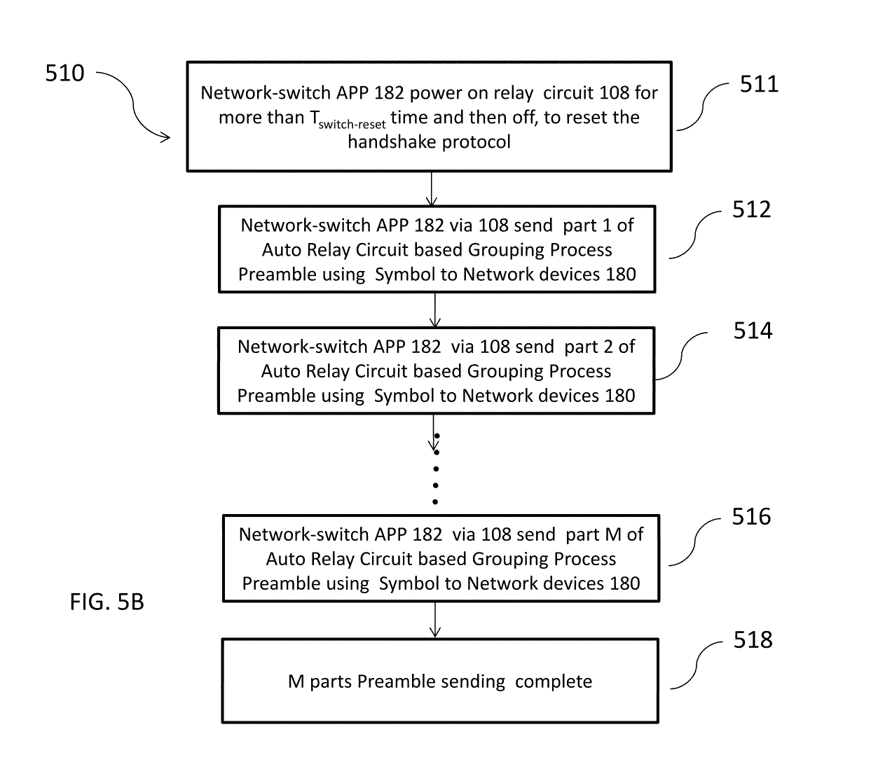

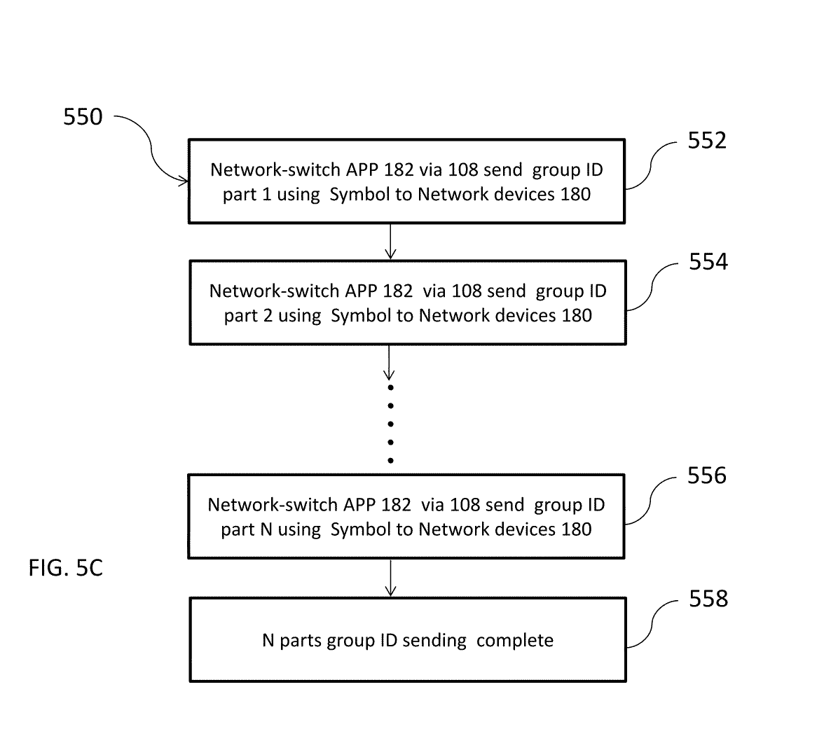

The automated relay/switch circuit based grouping process 500 runs on each network-switch device when instructed by step 4500 of the commission firmware process 4000 over the control channel 128 detailed in FIG. 5A. Note that the process 500 is executing on the embedded software 182 of the individual network-switch device. Since all the network-switches are controlling a separate power circuit 108 that it is using for the process, process 500 on all the network-switch devices 180 on system 130 can run independently and concurrently. Process 500 of network-switch 180 sends a preamble over the power line 108 to signal to all the network devices connected on its relay to indicate that it is running the auto-grouping protocol (510).

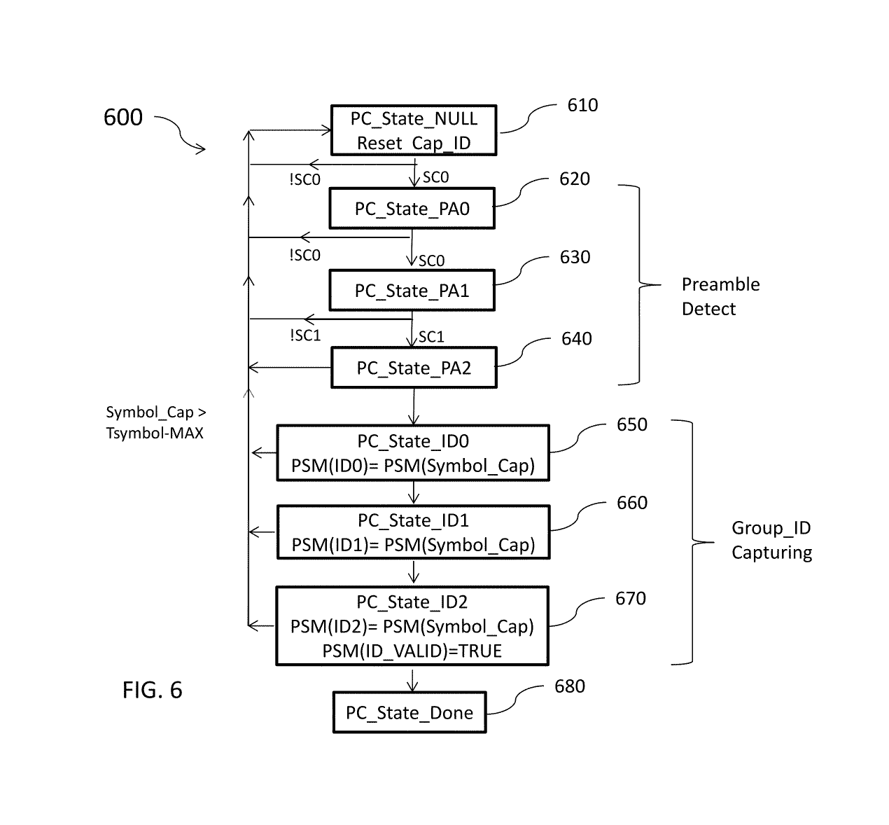

The operation of 510 is detailed in FIG. 5B according to one embodiment, which depicts the sending of the preamble symbols as M consecutive symbols over the control wire 108. Note that each of the M symbols are delivered on the relay wire 108 as timed power on and power off from the relay built into the network-switch 180 that will be described in further detail later herein. The process 510 sends a symbol that is more than a maximum number of symbols pre-defined as a reset signal to the network lighting devices 170 connected to it (511). Alternatively, this reset signal can be broadcast from the commissioning device 190 during step 4500 of process 4000. Following that, the first of the M-symbol preamble is sent (512), then the second symbol of the preamble (514) is sent, and so on until the M symbol of the preamble is sent (516) and all of the M pre-defined symbols are transmitted (518). While the preamble can be any consecutive sequence of symbols, it is recommended that it be a series of zero symbols followed by a one symbol. For example, a 3-binary number coded preamble of “001” can serve as the preamble. In an alternate embodiment, the sending of a preamble can be skipped if the commission step 4500 also informs the network-devices to run group ID capturing steps of process 600 in FIG. 6 while signaling to the network-switch devices to start the automated relay/switch circuit based grouping process over the network 128.

After the network-switch device 180 sends the preamble, it sends its unique group ID acquired in step 4100 of process 4000 (550). The operation of 550 is detailed in FIG. 5C according to one embodiment, which depicts the sending of the unique group ID as N consecutive symbols over the control wire 108. For example, the transmitted symbols may be N bits of binary code that represent the group/zone number/ID. For instance, if there are 256 groups in the system, then an 8-binary bit symbols can be used. Alternatively, if each symbol can represent 4-bit (hexadecimal), then transmission of 2 symbols is sufficient for the signaling. Instead of sending a fixed length code for the group ID, alternatively, a more efficient and flexible approach would be to for each network-switch to send only the number of symbols necessary to represent its group ID and then end it with a special “End Symbol” to signal the end of transmission.

FIG. 6 illustrates the process 600 running on all the network-lighting devices 170 to receive the unique group ID from their respective network-switch device. Process 600 runs like a state machine except is clocked by the power on/off cycle of the network-device itself. At any power cycle, state information must be read from the persistent memory of network-lighting device 170 and processed, and the new state information stored back into the persistent memory before it is power off.

Process 600 is initialized to start at the so called PC_State_NULL by step 511 of process 510 at which point the persistent memory storing the group ID is reset (610). Alternatively, it can be initialized by step 4500 of process 4000 as mentioned earlier. In process 600 the network lighting device 170 scans for a valid M parts preamble (step 620 to 640) over M consecutive power cycles. For simplicity, a 3-symbol preamble of “001” is used and for this example the preamble sequence expected is a (SC0) symbol 0 (620), followed by another SC0 (630), follows by a (SC1) symbol 1 (640). The preamble sequence should be defined so as to avoid accidental trigger and detection of the preamble. While a 3-symbol preamble sequence is shown, the longer the preamble, the lower the probability that a false preamble is generated and erroneously detected. Note that if the expected preamble is not received during the sequence (620-640), the process 600 would reset to the PC_STATE_NULL and the hunt for a valid preamble will restart. The requirement for detecting the preamble in consecutive cycles provides better protection against false preamble.

The successful completion of step 640 would start the group ID capturing steps. For simplicity, an example of a fixed length 3-symbol group ID is shown to be captured in the next 3 power cycles (650 to 670). If each symbol represents a binary code, then the fixed length 3-symbol group ID is able to represent a group size of 8: group ID 0 to 7. When the last symbol has been captured by step 670, the network lighting device 170 saves the group ID in its persistent memory and signals to the commissioning device 190 that a valid group ID has been captured by it and it represents the group that it belongs. At the completion of process 600, the commissioning of all the relay circuit based groups such as 162 and 164 on network system 130 is complete. Note that a network device would respond to all commands issues on the control network 128 if the command is either addressed directly to its' network ID or the group ID that it belongs to.

The commissioning device 190 at this point collects the group information of the reporting network devices and creates the corresponding mapping of the groups into the database (4800). For example, the network devices in group 162 could have been assigned a group ID of 1, and the network devices in group 164 could have assigned a group ID of 2. Following the example, using the group ID of 1, the commissioning device 190 and/or the network switch devices 180 of the group/zone 162 have the handler to control the group of network devices on group/zone 162. Similarly, group/zone 164 can be controlled by the commissioning device 190 and/or the network switch device 180 of the group/zone 164 using group ID 2. Hence the automated relay/switch circuit based grouping process 4000 is complete. Imaging having hundreds of switches in a building. Their natural device groupings are created easily and quickly with automation and concurrency saving the commissioner a lot of time and effort. For many retrofit and even new systems, that may be the single most important feature for the daily users.

It will be apparent later that the automated group information, if utilized efficiently in a smart graphic interface, will exemplify that advantage and the overall efficiency of the commission process.

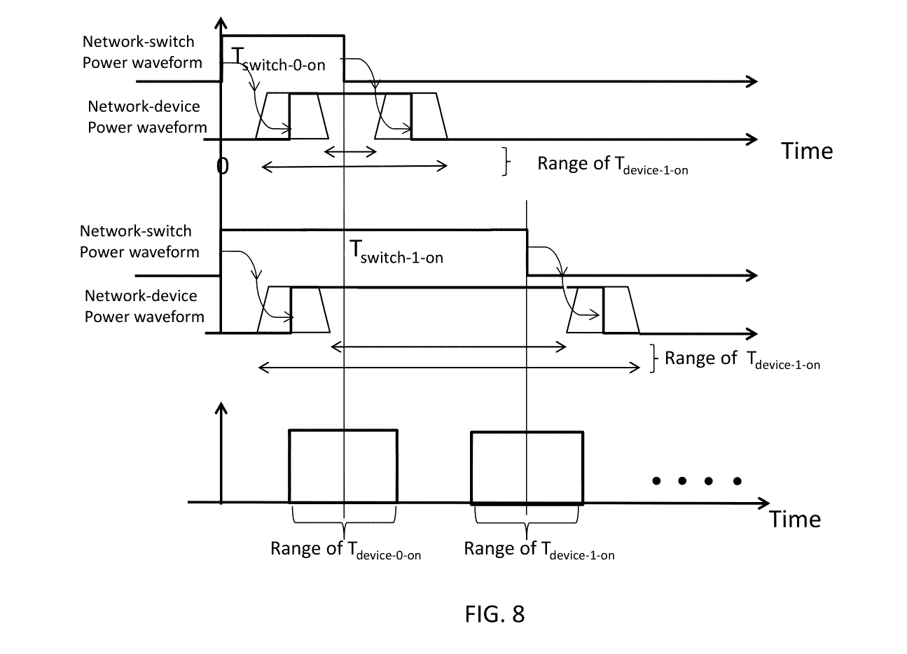

It has been mentioned that a symbol is transmitted from the network-switch device 180 to all the attached network-lighting devices 170 on the relay power circuit 108 by timed sequences of power on and off using the built in relay in the network-switch 180. How the symbols can be defined, transmitted, and received will now be described, according to some embodiments. Basically, a protocol is established between the network switch device and the network lighting devices that the captured Tdevice-on time by the network lighting device represents a symbol that the network switch device is sending over. Unique symbols are created by assuring that the Tdevice-on times captured by the network lighting device 170 for the different symbols are non-overlapping. The timing relationship that guarantees the captured Tdevice-on times for all the symbols are non-overlapping is shown in FIG. 8. Taking into account the network devices power-on and power-off characteristics in system 130, the network switch controls the T_{switch-on} time to send a specific symbol.

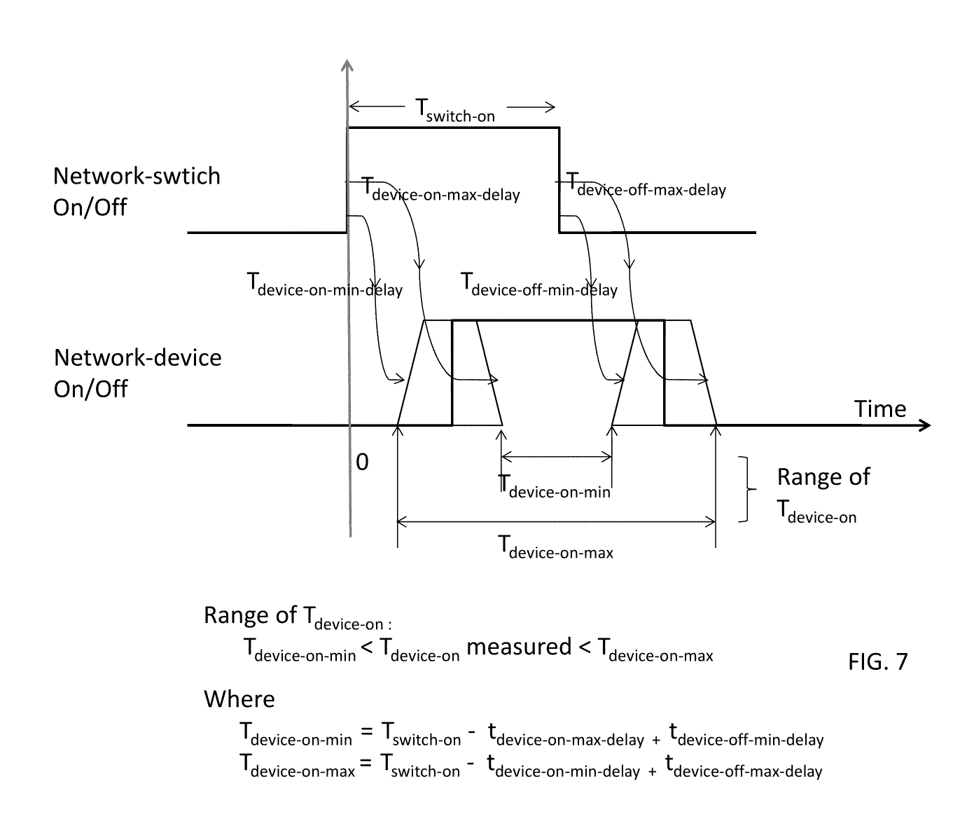

FIG. 7 depicts the various timings of the signaling mechanism according to one embodiment. These timing parameters are further described here:
T_{switch-on}: the amount of time that the network-switch device turns on the relay to power the circuit 108 to send a symbol. A unique T_{switch-on} is used for each unique symbol. The timing is chosen such that it satisfies the all timing variations of network lighting devices 170 on the relay circuits of system 130. The timing is also easily controlled/captured by the embedded processor or a timer state machine embedded in the network devices (180 and 170) of system 130. T_{switch-0-on}, T_{switch-1-on}, to T_{switch-n-on} represent the N timings that the network-switch device needs to turn on the relay switch to transmit a symbol 0, symbol 1, to symbol n respectively as shown in FIG. 8. In order for the Tdevice-on time captured by the network lighting device for the individual symbols to be non-overlapping and unique, the following requirements for T_{switch-on} is required:
For symbol 0: T_{switch-O-on}−t_{device-on-max-delay}+t_{device-off-min-delay}>T_{processing}
For symbol n: T_{switch-n-on}>T_{switch-n-1-on} t_{device-on-min-delay}+t_{device-off-max-delay}+t_{device-on-max-delay}−t_{device-off-min-delay}
t_{device-on-delay}: the hardware time delay from the time the network-switch device 180 turns on the relay to power the circuit 108 to the moment the MCU or state machine on the network lighting devices power up. This hardware dependent time delay is typically the sum of the switch relay turn on time, the network lighting device power electronics turn-on time, and the MCU or state machine boot up time. It can be measured and characterized easily and can range from hundreds of milliseconds to seconds. The system wide minimum and maximum of the t_{device-on-delay} are represented as t_{device-on-min-delay} and t_{device-on-max-delay} respectively due to variations in hardware components.
T_{processing}: the minimum time needed by the network-lighting device 170 to process the protocol; typically in milliseconds.
t_{device-off-delay}: the hardware time delay from the time the network-switch device 180 turns off the relay to power off the circuit 108 to the moment the MCU or state machine on the network device is power off. This hardware dependent time delay is typically the sum of the switch relay turn off time and the network device power electronics turn-off time. It can be measured and characterized easily and can range from 100s' of milliseconds to seconds. The system wide minimum and maximum of the t_{device-off-delay} are represented as t_{device-off-min-delay} and t_{device-off-max-delay} respectively due to variations in hardware components.
T_{device-on}: the device power cycle on-time that the network-lighting device 170 captured into its persistent memory. Due to device and component timing variations, T_{device-on} time varies between t_{device-on}_{_}ₘᵢₙ and T_{device-on-max} where: T_{device-on}_{_}ₘᵢₙ=T_{switch-on}−t_{device-on-max-delay}+t_{device-off-min-delay} T_{device-on}_{_}ₘₐₓ=T_{switch-on}−t_{device-on-min-delay}+t_{device-off-max-delay} T_{device-0-on}, T_{device-1-on}, to T_{device-n-on} represent the N timings that the network-lighting device used to interpret a captured of symbol 0, 1, to n respectively. Again, two symbols are distinguishable when T_{device-on-n}_{_}ₘᵢₙ>T_{device-on-n-1}_{_}ₘₐₓ

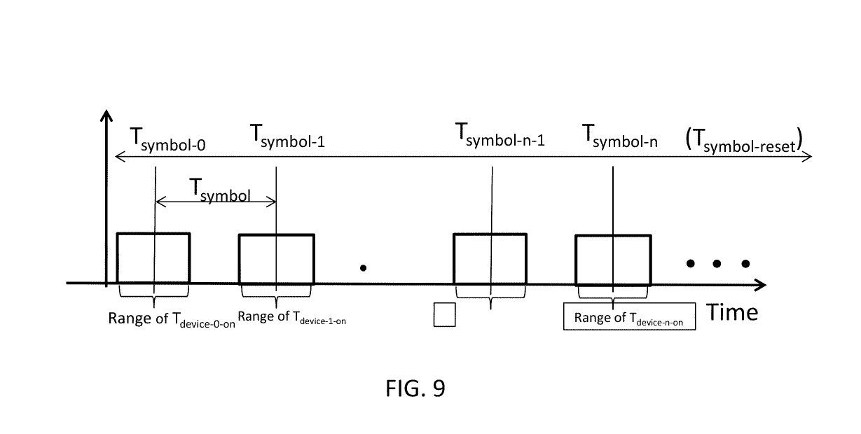

FIG. 9 depicts the non-overlapping symbols T_{symbol-0} to T_{symbol-N-1} on a time line. While other methods are possible, a “reset” symbol can be defined as the longest symbol T_{symbol-max} to be used as a signal to reset the symbol capturing process 1000 of the network devices.

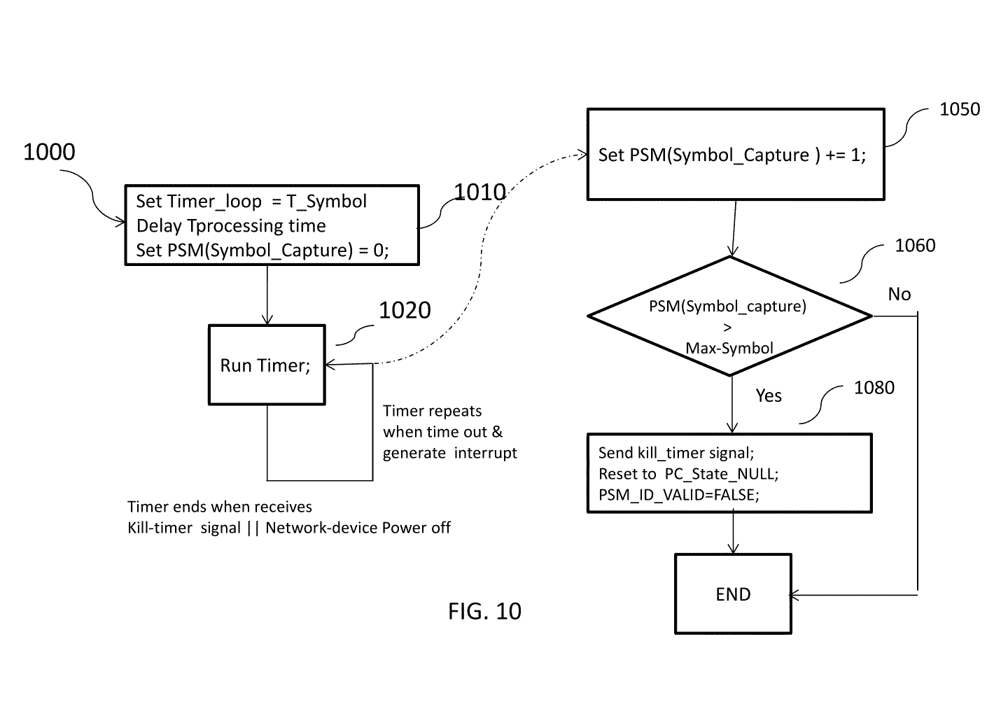

FIG. 10 depicts one embodiment of the symbol capturing process 1000 running on network-lighting device 170 according to one embodiment. Note that while it is possible for the network-lighting device 170 to measure its own T_{device-on} time, it may not be convenient to store the measured time into persistent memory right before power is turned off. Rather, in process 1000, a timer is set to run in a loop of T_{symbol} time (1010). Every time the timer expiring while the network-device is still power-on, a new symbol to be captured/logged into the persistent memory (1050). The process 1000 continues either until network-lighting device 170 is powered off or until the symbol capture is greater than or equal to the max symbol defined at which point the handshake protocol is reset (1080). Note that process 600 and process 1000 can be running as a single threaded process on network-lighting device 170 in some embodiments. Note that the timing/symbol capture implementation may vary, as long as the definition of the symbols is uniquely distinguishable and reliably captured by the network-lighting device.

Note that the present invention defines a method and protocol that is active during the short initial power up time of the network lighting devices and therefore consumes minimal processing power of the network lighting devices. And since the signaling is performed on the power circuit 108 which is wired and that all the network-switch devices 180 are independently powering a circuit 108, the automatic grouping process can run concurrently thereby greatly reduce the time needed for the process. The present invention advantageously fills the aforementioned deficiencies by providing automatic grouping of network devices.

The present invention system and method is unique when compared to known systems and solutions because the present invention: 1) is able to group all the switch groups concurrently so commission time is drastically reduced; 2) does not require additional hardware tools such as a pointing/signaling wane; 3) allows the system to be commissioned out of the box when powered; 4) no special modulation is needed on the power circuit wires thereby reducing hardware cost; and 5) since all internet of things or networked devices are equipped with an MCU and persistent memory, and the algorithm for running the auto-commissioning process is so simple and small, it will fit and run in most existing IoT hardware.

### Automated Locate of a Targeted Network Lighting Device

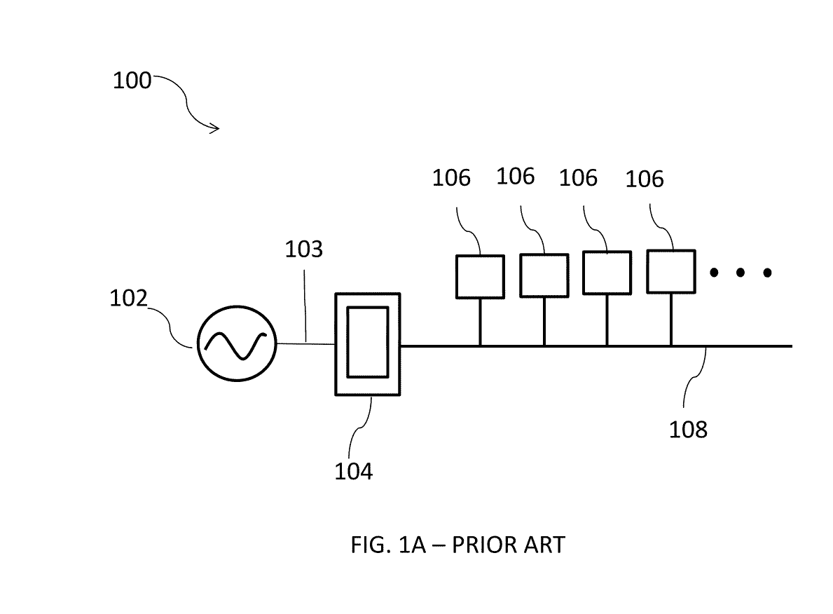

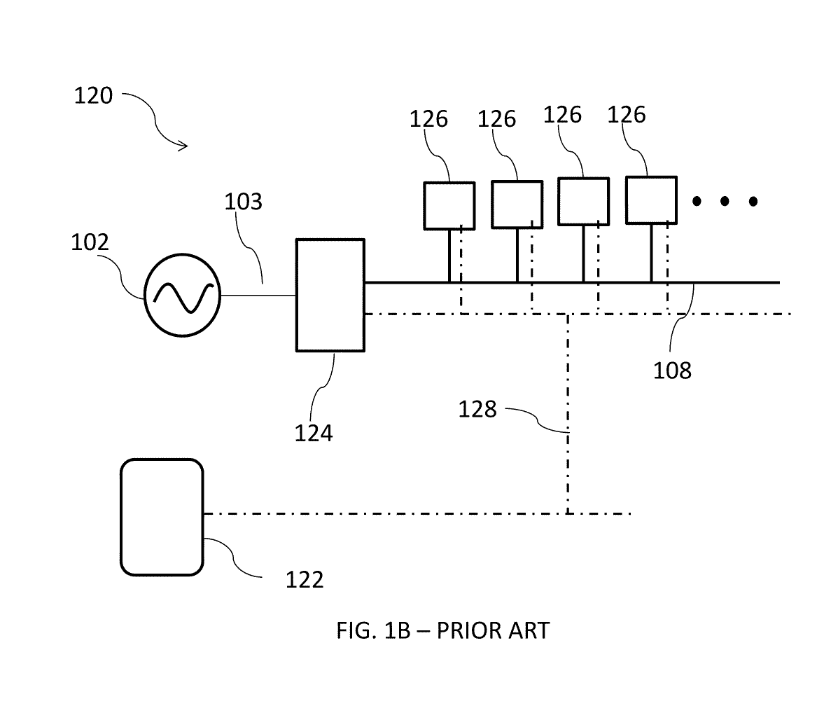

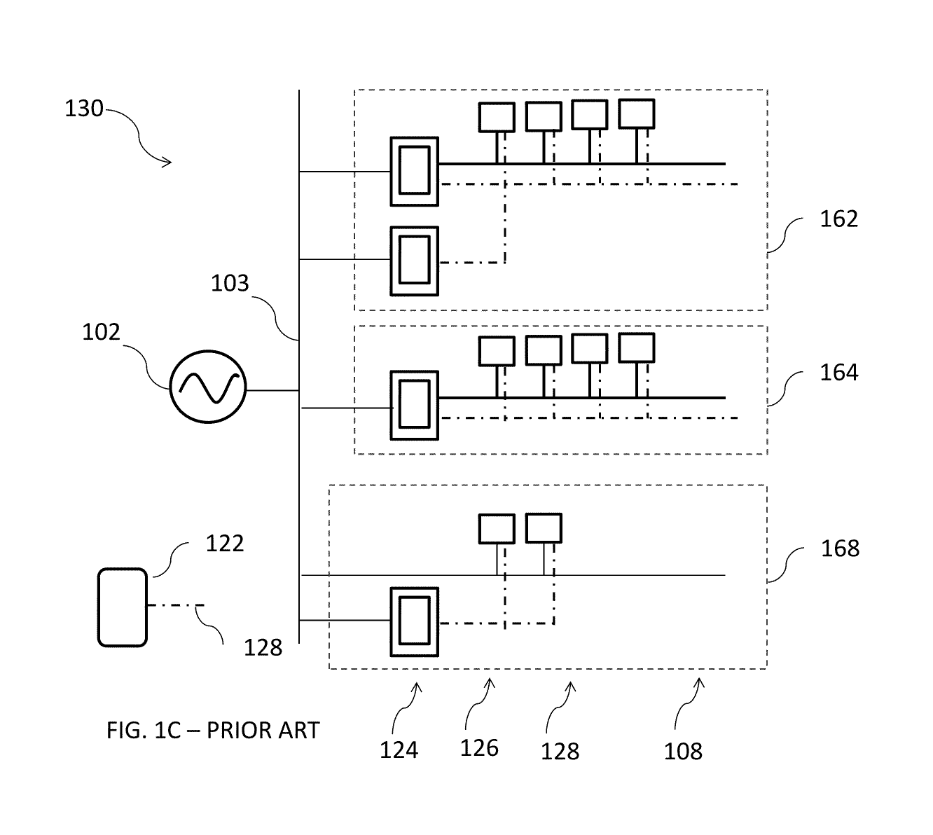

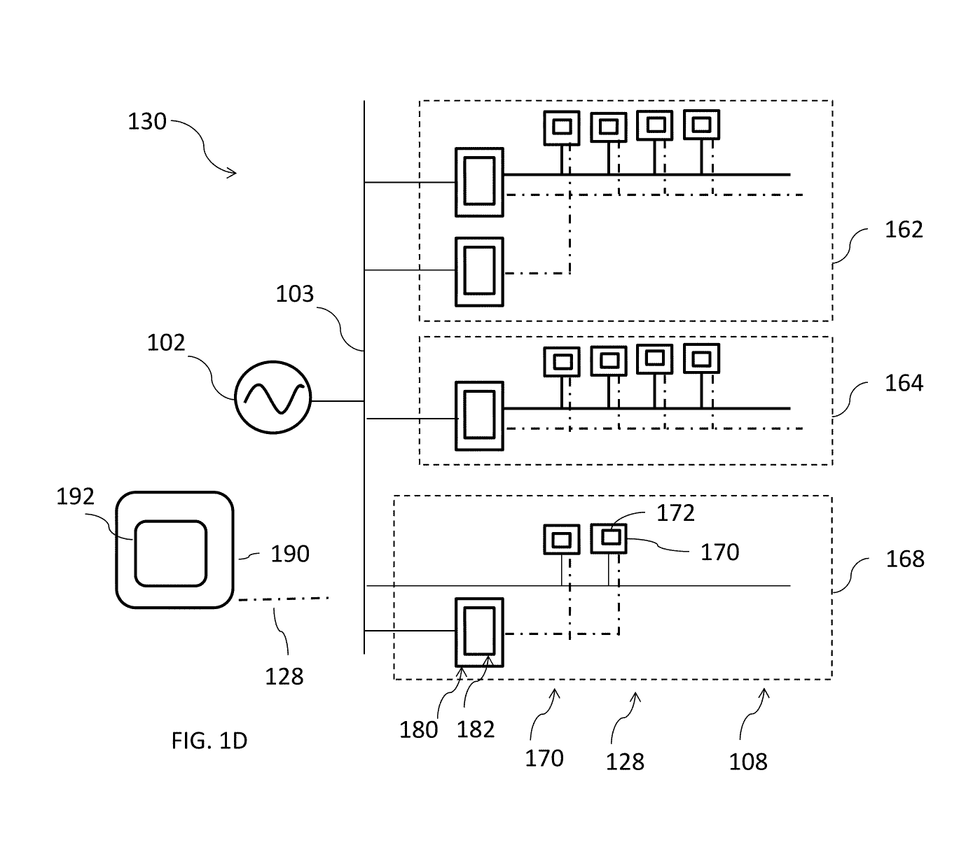

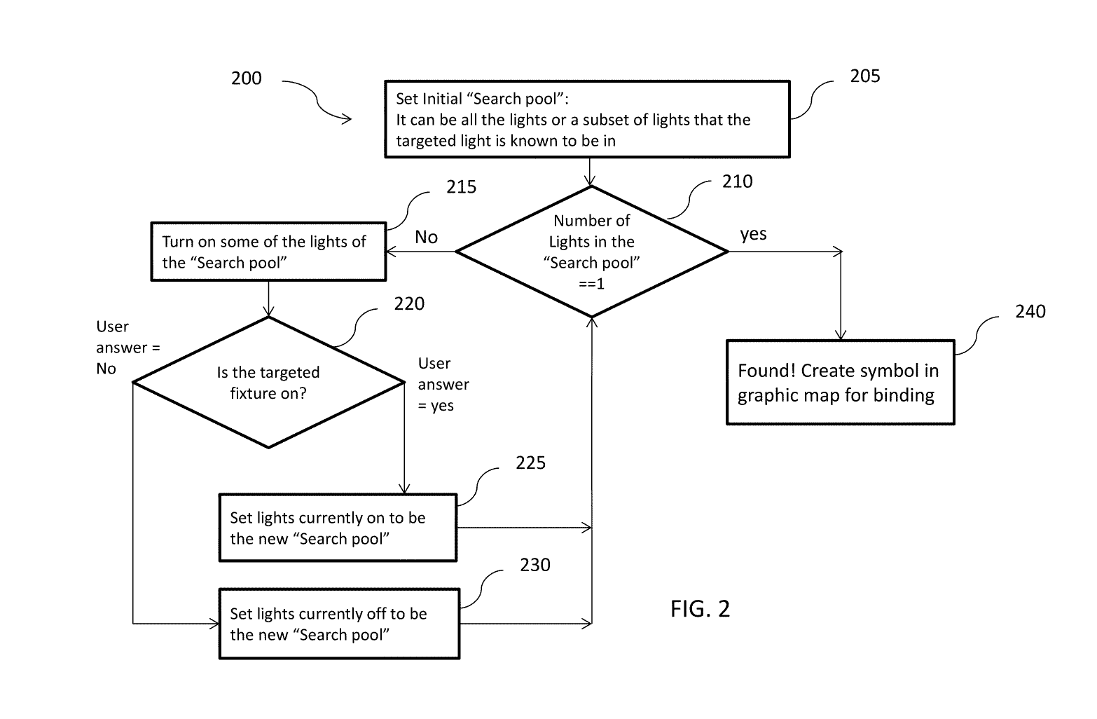

While auto-grouping is easy and fast for the commissioning of a network control lighting system, some form of custom configuration may be desirable and may be a requirement for a commissioning tool/software. To be able to perform any custom group/zone configuration, one must first bind the physical location of a network device to its logical representation in the commissioning tool/software. The automated process of binding a targeted network device is described with reference to FIG. 2 which is a flow diagram of an example process 200 for automated locate of a networked lighting device. The process 200 can be implemented in the commissioning device 190 of the system 130 illustrated in FIG. 1D. The commissioning device 190 may be a tablet, laptop, a hand-held computer, or a combination of a server with the attached application software. The commissioning device 190 includes commissioning software 192 for performing the process 200. As described in more detail below, the software may include a graphical user interface that graphically represents the lighting devices in the network and assists in locating the target network lighting device. In general, the process described is repeated to bind as many network lighting devices as necessary.

When the user starts the commissioning software 192 running on the commissioning device 190, a discovery process is invoked where the software 192 broadcasts a discovery command onto the network 128 and the embedded firmware 172 running on all the network lighting devices would then response to the broadcast and register itself to the commissioning software 192. A database of all the network lighting devices that have joined the network is then created and maintained in the commissioning device 190. The process 200 running on the commissioning device 190 sets the initial search pool to be all the network lighting devices 170 in the control system (205). It is noted that the initial search pool can be optionally set by the user to reduce search time if the target network device is known by the user to be in a much smaller logical representation group. For example, a smaller search group maybe a group of lighting devices in a conference room automatically configured by the Automated Relay Based Grouping.

The process checks if the size of the current search pool is one (210). If the size of the current search pool is one, that one network lighting device remaining in the pool is the target network lighting device.

If the size of the search pool is greater than one, the process automatically turns on some (e.g., half) of the network light devices in the pool (215). In one embodiment, the process then prompts the user for a response on whether the target network lighting device is one of the devices currently on (220). In another embodiment, the commissioning device 190 includes an attached or embedded light sensor such as a camera that can be used to automatically detect if the target lighting device is on. If the answer from the user is yes, the process sets the new search pool to be the group of network lighting devices currently turned on (225). If the answer is no, the process sets the new search pool to be the group of network lighting devices currently off (230). Either case, the process jumps back to check the updated size of the search pool (210). The process repeats until one network lighting device is left. This process will complete the identification process in log 2N steps where N is the size of the initial search pool.

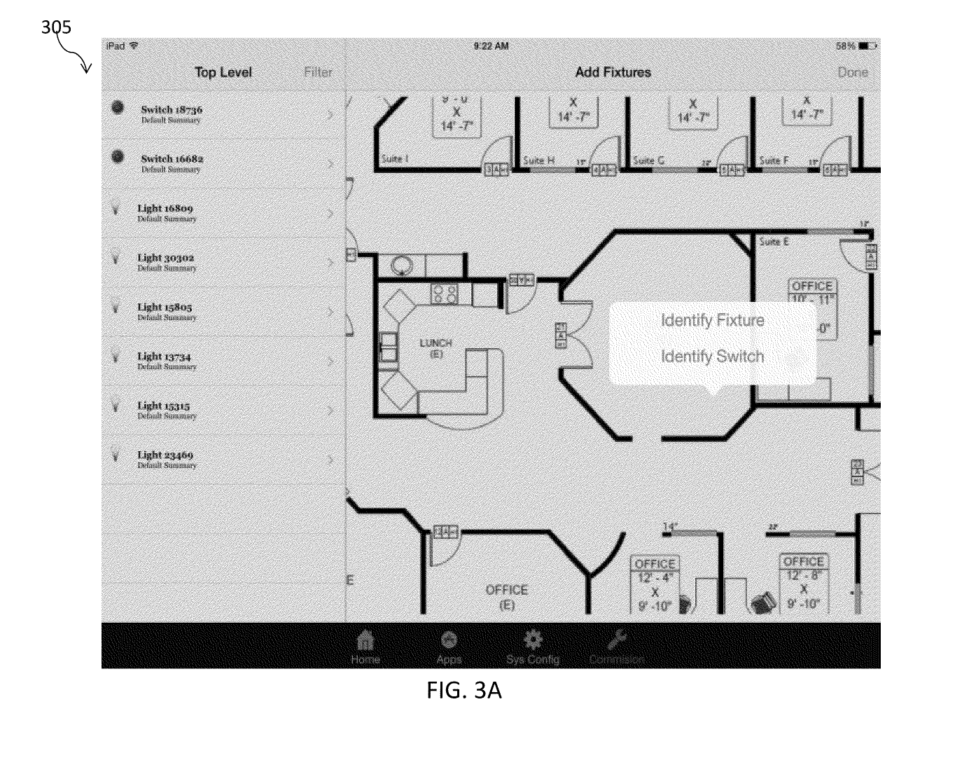

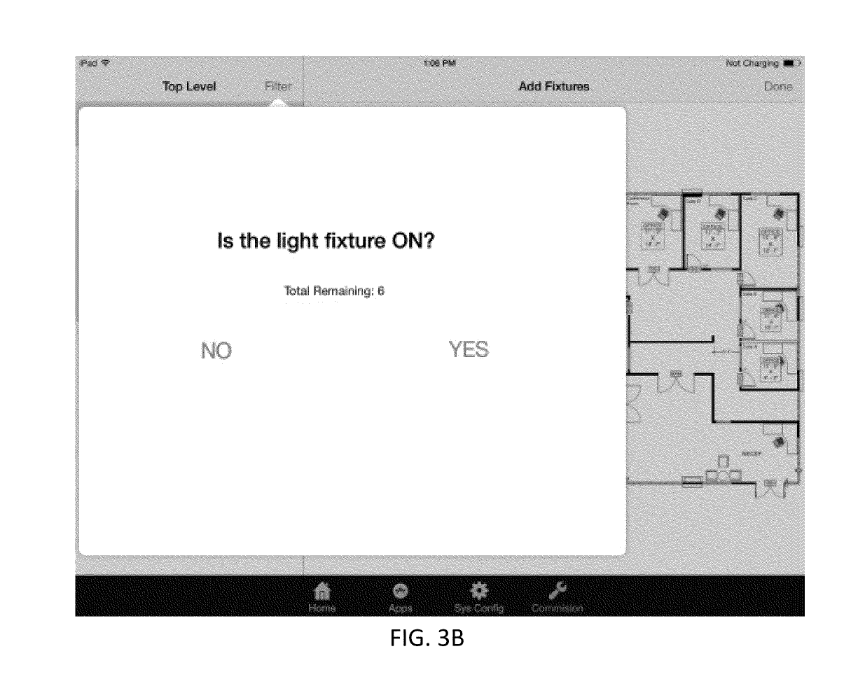

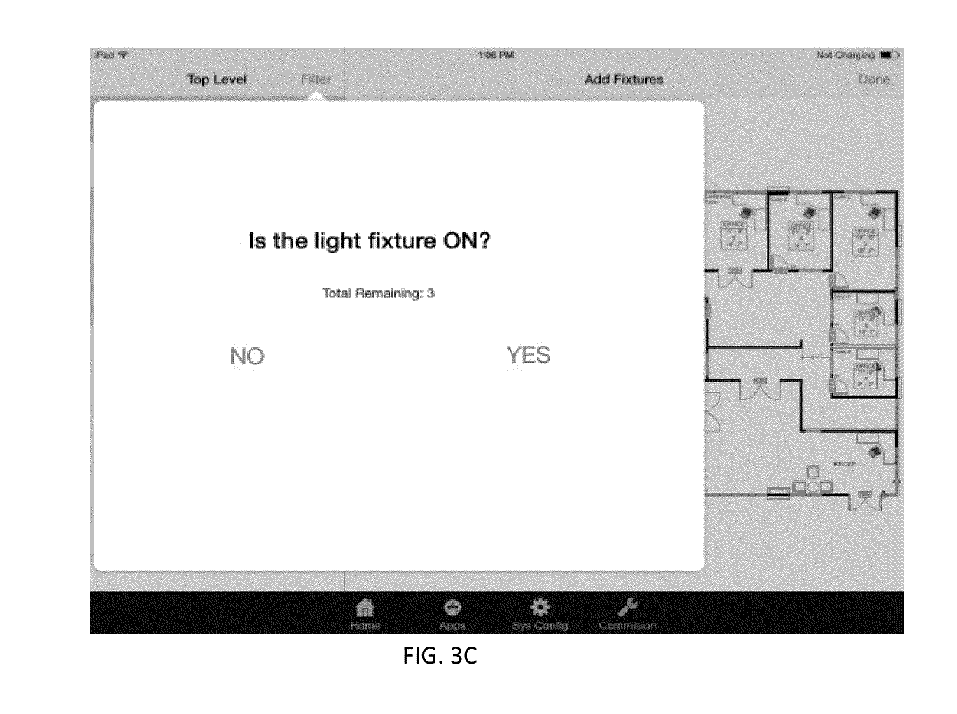

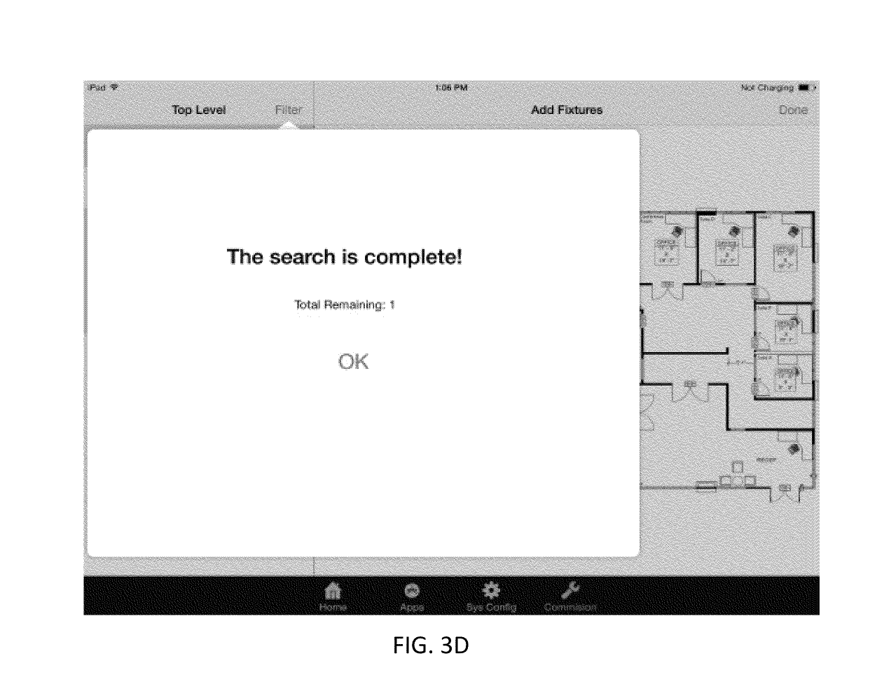

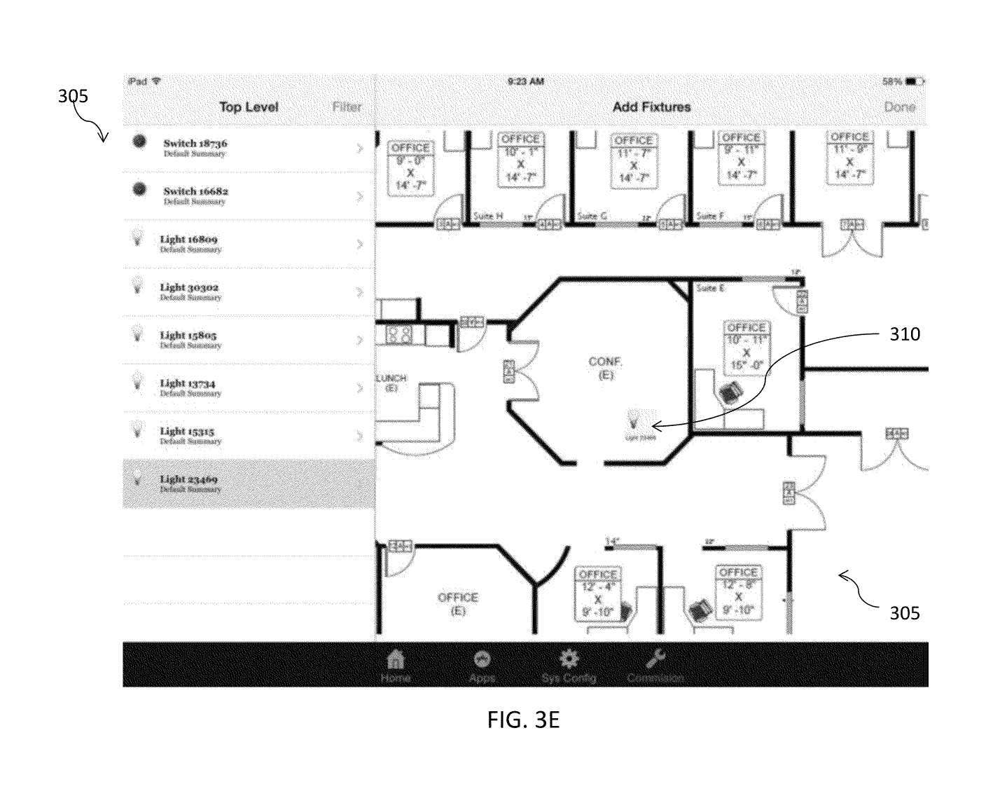

The process 200 is especially effective when implemented in the exemplary Graphic Map user interface shown in a progression of screenshots in FIGS. 3A-E. To start off, any graphic image 305 can be incorporated into the commission software 192 to provide cognitive association of the binding. Assuming graphic image 305 in FIG. 3A is used as the floor plan, the process 200 can be conveniently initiated by tapping/clicking on a location on the graphical map 305 where the target network lighting device is to be logically and symbolically represented/located. An iteration of steps 210 to 230 of process 200 requires the user to confirm if the target network lighting device is on. FIG. 3B shows an exemplary user interface to acquire the user response. In the case where the target network device is a lighting device, the feedback would be whether the light is on. Note that FIG. 3B to 3D progressively shows the size of the current search pool reducing. For example, FIG. 3B prompts the user whether the targeted lighting device is on, shows the total lighting devices remaining in the search pool (in this example a total of 6), and allows the user to specify whether the targeted lighting device is on or off. FIG. 3C shows the shrinking size of the current search pool (in this example a total of 3) and prompts the user whether the targeted lighting device is on in a manner similar to that illustrated in FIG. 3B. FIG. 3D shows a screen when the search is complete. At step 240, an icon representing the found/target network lighting device is automatically placed at the location of the graphic map 305 where the search was initiated to complete the binding. For example, FIG. 3E shows the found/target network lighting device 310 in the graphic map 305.

The Automated Locate method for binding is very efficiently executed within the graphic map user interface requiring minimal actions from the user. The process 200 does not require additional tools other than the commissioning device 190. In another embodiment the confirmation of whether the target lighting device is on throughout the process can be acquired automatically by using a built-in camera on the commissioning device 190 (if included). By pointing the camera directly to the target lighting device, the commissioning software 192 can deduce from the captured image if the targeted lighting device is on by detecting a sharp contrast in the camera image.

### Another Embodiment of the Invention

Having described embodiment(s) of the invention, alternative embodiment(s) will now be described. Like the previous embodiment(s), these alternative embodiment(s) allow for Automatic Binary Locate and Switch/Relay Power Circuit/wire based Automatic Grouping. However, unlike the previous embodiment(s), these embodiment(s) use a feedback sensor, for example the CMOS camera on a tablet running the commission application software. In the case of a lighting device being the target network device, the user would point the camera of the tablet running the application at the targeted lighting device. In this case, a software application can be employed to replace the user feedback by providing automatic feedback to the Automatic Binary Locate method.

### Alternative Embodiments

While embodiments of the invention have been described in relation to turning on and off of lighting devices, other feedback method such as using an LED visual indicator can be used. Therefore, embodiments of the invention are not limited to turning on and off of lighting devices. In addition, while embodiments of the invention have been described in relation to the initial search pool being all the network devices connected, alternative embodiments could be implemented such that the initial search pool is a smaller size group which the user knows from other information that the network device target belongs. For example, through the use of the Switch/Relay power circuit/wire based auto-grouping method, groups were automatically created and one of these smaller groups can be used as the starting point of the search pool. Such an embodiment could be implemented within the graphic map user interface. Another method of having a smaller starting search pool may even use proximity sensors that reduce the starting search pool to network lighting devices that are closer to the user or a proximity beacon. Also, while the method is described in the form of a binary search algorithm, depending on the nature of the network devices being bind, a modified divide and conquer algorithm can be employed if it can opportunistically reduce the Order of the algorithm. For example, the CMOS camera can be used to automatically bind a number of targeted lighting devices instead of just one. The size of the targeted lighting devices at one time is limited by the line of view of the camera which can be further expanded with a fish-eyed lens.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

As described herein, instructions may refer to specific configurations of hardware such as application specific integrated circuits (ASICs) configured to perform certain operations or having a predetermined functionality or software instructions stored in memory embodied in a non-transitory machine readable medium. Thus, the techniques shown in the figures can be implemented using code and data stored and executed on one or more electronic devices (e.g., network switch device, network lighting device). Such electronic devices store and communicate (internally and/or with other electronic devices over a network) code and data using machine-readable media, such as non-transitory machine-readable storage media (e.g., magnetic disks; optical disks; random access memory; read only memory; flash memory devices; phase-change memory) and transitory machine-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for automated locate of a targeted network lighting device, comprising:
(a) setting a search pool as a plurality of network lighting devices;
(b) automatically turning on a portion of the plurality of network lighting devices, wherein the portion is less than the plurality of network lighting devices;
(c) determining whether the targeted network lighting device is one of the portion of plurality of network lighting devices turned on;
(d) responsive to determining that the targeted network lighting device is not turned on, performing the following:
(1) automatically turning off the portion of the plurality of network lighting devices that are turned on;
(2) automatically turning on a different portion of the plurality of network lighting devices, and
(3) repeating step (c),
(e) responsive to determining that the targeted network lighting device is turned on, determining whether the targeted network lighting device is the only network lighting device turned on;
(f) responsive to determining that the targeted network lighting device is one of a second plurality of network lighting devices turned on, performing the following:
(1) setting the search pool as those plurality of network devices,
(2) repeating steps (b)-(f) until the targeted network lighting device is the only network lighting device turned on; and
(g) responsive to determining that the targeted network lighting device is the only network lighting device turned on, setting that network lighting device as found.
